(19) United States
(12) Patent Application Publication
(10) Pub. No.: US 2015/0064633 A1
(43) Pub. Date: Mar. 5, 2015

(54) MULTI-TOOL LIGHTER

(71) Applicants: Christopher Dominguez, La Mirada, CA (US); Giovanny Garcia, Whittier, CA (US)

(72) Inventors: Christopher Dominguez, La Mirada, CA (US); Giovanny Garcia, Whittier, CA (US)

(21) Appl. No.: 14/012,857

(22) Filed: Aug. 28, 2013

(51) Int. Cl. F23Q 2/32; B23P 11/00

(52) U.S. Cl. CPC F23Q 2/32; B23P 11/00
USPC 431/253; 29/428

(57) ABSTRACT

A lighter houses tools commonly used in smoking hand rolled cigarettes, pipes, and THC (medicinal marijuana). The tools housed in the lighter may include a poke tool and/or a tweezers and dab combination tool. The tools may swing out from the lighter housing into an open position where they may be used. The lighter housing may act as a handle for the tools while in an open position.

### TECHNICAL FIELD

This disclosure relates to the field of cigarette lighters and in particular to a multi-tool lighter.

### BACKGROUND

Hand rolled cigarettes made from loose tobacco and the use of loose leaf tobacco in pipes have existed for a long time. Over time, certain tools that aid in smoking tobacco from a hand rolled cigarette or pipe have been developed. In addition, medicinal marijuana usage has also been around for a long time in various forms. Marijuana may be smoked in hand rolled cigarettes, pipes, and additionally may be utilized in the form of pure Tetrahydrocannabinol (THC). THC is the chemical responsible for most of marijuana's psychological effects. In its medicinal form THC is a waxy substance that is scooped out of a container in small dosages to be smoked. Because smoking pure THC is a relatively new concept, the instruments used in the process are still evolving. The tools used for smoking loose leaf tobacco or marijuana and the tools used for smoking pure THC, however, are different. There has never been a convenient way to carry such tools, and carrying around both sets of tools can be cumbersome.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one embodiment, an apparatus comprises a lighter housing having a flame emitter portion at a first end of the lighter housing, and a tweezers and dab combination tool and a poke tool coupled to the lighter housing at a second end. The tweezers and dab combination tool includes a pair of elongated arms connected at a mating end, each arm of the pair of elongated arms having a free end opposite the mating end and positioned adjacent the free end of the other arm, where a tip of each free end is angled away from a central axis of the elongated arms to form a dab portion of the tool, and wherein the mating end is coupled to the lighter housing. The poke tool comprises a rod, having a base end and a tip end, wherein the base end of the rod is coupled to the lighter housing.

The lighter housing includes a cavity recessed within one side of the housing, the cavity extending at least a portion of a length between a second end and the first end, the cavity to house the tweezers and dab combination tool and the poke tool when the tweezers and tab combination tool and the poke tool are in a closed position. The tweezers and dab combination tool and the poke tool are coupled to the housing by a pin, the tweezers and dab combination tool and the poke tool to independently pivot on a radial axis around the pin between the closed position and an open position.

The tweezers and dab combination tool further comprise a middle portion where the elongated arms bend away from each other, the elongated arms to separate from each other at the free ends when the middle portion of each elongated arm is pressed together, an inner portion of each elongated arm having a striated gripping surface, and a ring at the mating end, to encompass a pin in the housing, the pin to couple the tweezers and dab combination tool to the housing. The poke tool also includes a ring at the base end, to encompass a pin in the housing, the pin to couple the poke tool to the housing.

The dab portion of the tweezers and dab combination tool may include a beveled tip, the tip forming a point on one edge of the elongated arms at the free end. The dab portion of the tweezers and dab combination tool may include a pointed tip along the central axis of the elongated arms at the free end. The dab portion of the tweezers and dab combination tool may include a rounded tip, forming a smooth radius at the free end.

In one embodiment, a method includes manufacturing a lighter housing comprising a flame emitter portion at a first end of the lighter housing and coupling a tweezers and dab combination tool to the lighter housing. The tweezers and dab combination tool may include a pair of elongated arms connected at a mating end, each arm of the pair of elongated arms having a free end opposite the mating end and positioned adjacent the free end of the other arm, where a tip of each free end is angled away from a central axis of the elongated arms to form a dab portion of the tool, and wherein the mating end is coupled to the lighter housing.

Manufacturing the housing further includes creating a cavity recessed within one side of the housing, the cavity extending at least a portion of a length between a second end and the first end, the cavity to house the tweezers and dab combination tool and the poke tool when the tweezers and tab combination tool and the poke tool are in a closed position. A pin may be inserted into the rings on the tweezers and dab combination tool and the poke tool and coupled to the housing, the tweezers and dab combination tool and the poke tool to independently pivot on a radial axis around the pin between the closed position and an open position.

Manufacturing the tweezers and dab combination tool includes creating a middle portion where the elongated arms are bent away from each other, the elongated arms to separate from each other at the free ends when the middle portion of each elongated arm is pressed together, creating a striated gripping surface on an inner portion of each elongated arm, and creating a ring at the mating end, to encompass a pin in the housing, the pin to couple the tweezers and dab combination tool to the housing. Manufacturing the dab portion of the tweezers and dab combination tool further comprises creating a beveled tip, the tip forming a point on one edge of the elongated arms at the free end. Manufacturing the dab portion of the tweezers and dab combination tool further comprises a pointed tip along the central axis of the elongated arms at the free end. Manufacturing the dab portion of the tweezers and dab combination tool further comprises creating a rounded tip, forming a smooth radius at the free end.

### BRIEF DESCRIPTION OF THE DRAWINGS

The present disclosure is illustrated by way of example, and not by way of limitation, in the figures of the accompanying drawings.

FIG. 1 is a diagram illustrating a tweezers/dab combination tool and a poke tool housed inside a lighter, according to an embodiment.

FIG. 2a is a diagram illustrating a front view of a tweezers/dab combination tool, a poke tool, and a pin to couple them to a lighter, according to an embodiment.

FIG. 2b is a diagram illustrating a close-up view of a pin to couple the tweezers and dab combination tool and a poke tool to a lighter, according to an embodiment.

FIG. 3 is a diagram illustrating a side view of a lighter to house a tweezers and dab combination tool and a poke tool in a closed position, according to an embodiment.

FIG. 4 is a diagram illustrating a side view of a lighter to house a tweezers/dab combination tool and a poke tool in an open position, according to an embodiment.

FIG. 5a is a diagram illustrating a close-up view of a poke tool, according to an embodiment.

FIG. 5b is a diagram illustrating a side view of a poke tool, according to an embodiment.

FIG. 5c is a diagram illustrating a detailed view of the tip of a poke tool, according to an embodiment.

FIG. 6a is a diagram illustrating a close-up view of a tweezers/dab combination tool, according to an embodiment.

FIG. 6b is a diagram illustrating a detailed view of the tip of a tweezers/dab combination tool, according to an embodiment.

FIG. 6c is a diagram illustrating a side view of a tweezers/dab combination tool with the tweezers in a closed position, according to an embodiment.

FIG. 6d is a diagram illustrating a side view of a tweezers/dab combination tool with the tweezers in an open position, according to an embodiment.

FIG. 7 is a diagram illustrating a method of assembling a multi-tool lighter, according to an embodiment.

### DETAILED DESCRIPTION

Embodiments of a multi-tool lighter are described herein. In one embodiment, the multi-tool lighter includes a housing to connect the various components thereof. The lighter may function as a conventional lighter by producing a flame at a flame emitter portion. This flame can be used to light a cigarette, pipe, or other object. The multi-tool lighter, however, may additionally include a set of tools connected thereto for use in smoking activities. In one embodiment, these tools include a poke tool and a tweezers and dab combination tool. The tools may be rotatably connected to the housing so that they can fold between an open and closed position. In the closed position, the tools may be housed within a cavity of the housing, so as not to take up excess space.

In one embodiment, the poke tool can be used to facilitate the cleaning of ashes and debris from a pipe. The tweezers and dab combination tool can function as a cigarette holder to enable the user to smoke a cigarette to the end without suffering burns. One end of the tweezers may be angled to form a dab tool. The dab tool can be used to scoop pure THC, or another waxy substance, out of a storage container.

By having the tweezers and dab combination tool and the poke tool built-in to the lighter, a user can have access to all of the tools he or she may need in order to prepare, smoke, and clean a cigarette, pipe or wax. The multi-tool lighter combines multiple tools into a single device and stores these tools in a compact fashion. This prevents the user from having to carry around multiple tools at once. A user is also less likely to lose or misplace one the tools when they are all combined into a single device.

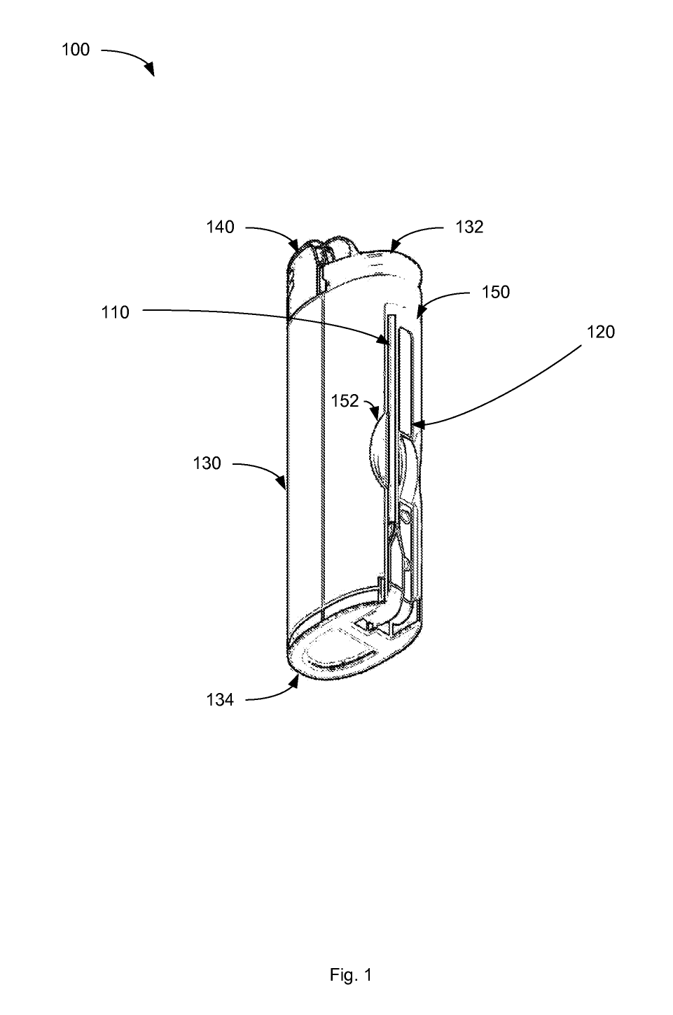

FIG. 1 is a diagram illustrating a poke tool 110 and a tweezers/dab combination tool 120 housed inside a lighter 100, according to an embodiment. The lighter 100 may be formed from a housing 130 having a first end 132 and a second end 134. In one embodiment, the lighter 100 may include a flame emitter portion 140 located at the first end 132 of the lighter housing 130. In one embodiment, the lighter 100 may be of the disposable variety, with the housing 130 made of plastic or some other inexpensive material. In another embodiment, the lighter 100 may be non-disposable and the housing 130 may be made of some type of metal or other material. In one embodiment, the lighter housing 130 may include a cavity 150 to house the poke tool 110 and the tweezers and dab combination tool 120. The cavity 150, inside of which the tools are housed, may have a cutout 152 or multiple cutouts on its sides to better reach the tools while in a closed position inside the lighter 100. In another embodiment the tools may have handles or some other means by which they may be accessed while in a closed position. In one embodiment the cavity 150 to house the tools may be on the backside of the lighter housing 130. In other embodiments the cavity 150 may be on other sides of the lighter housing 130.

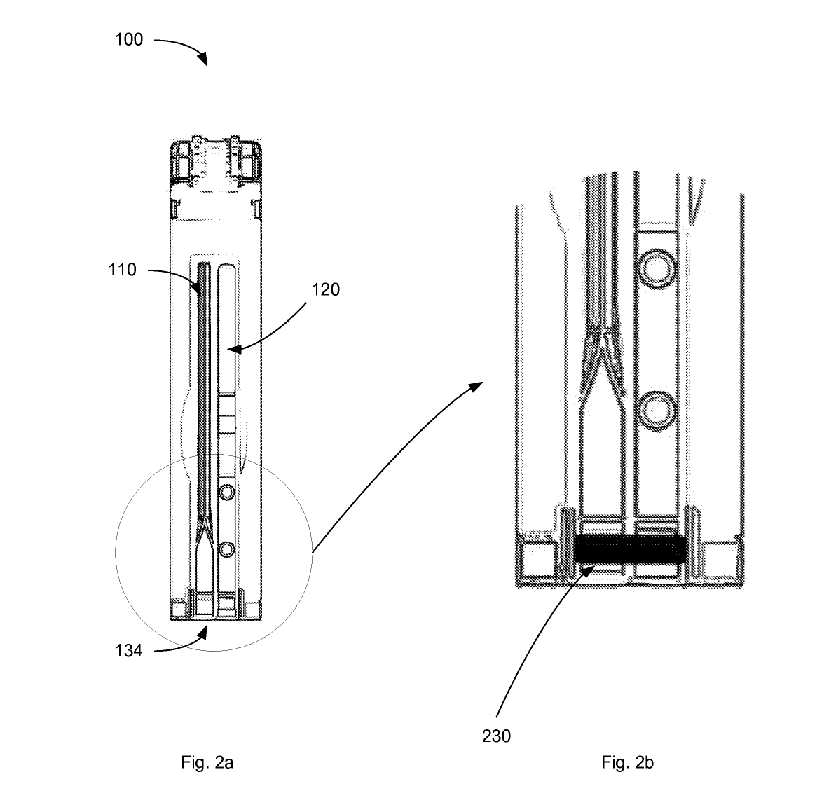

FIG. 2a is a diagram illustrating a direct view of a lighter 100, including a poke tool 110, a tweezers/dab combination tool 120, and a pin 230 to couple them to the lighter 100, according to an embodiment. In one embodiment, the pin 230 may couple the poke tool 110 and tweezers and dab combination tool 120 to the second end 134 of the lighter 100 as seen in FIG. 2b. FIG. 2b is a diagram illustrating an enlarged view of the second end 134 of the lighter 100, as shown by the circle in FIG. 2a. In this embodiment the tools may swing from a closed position out from the top of the lighter into an open position. In another embodiment, the pin 230 to couple the tools to the lighter 200 may be located at the top of the lighter 100 and the tools may swing from a closed position out from the bottom of the lighter 100 into an open position. In one embodiment the pin 230 may consist of a hard plastic. In another embodiment the pin 230 may consist of a metal. The pin may pass through a ring at a mating end of each of poke tool 110 and tweezers and dab combination tool 120 in order to secure the tools to the lighter 100.

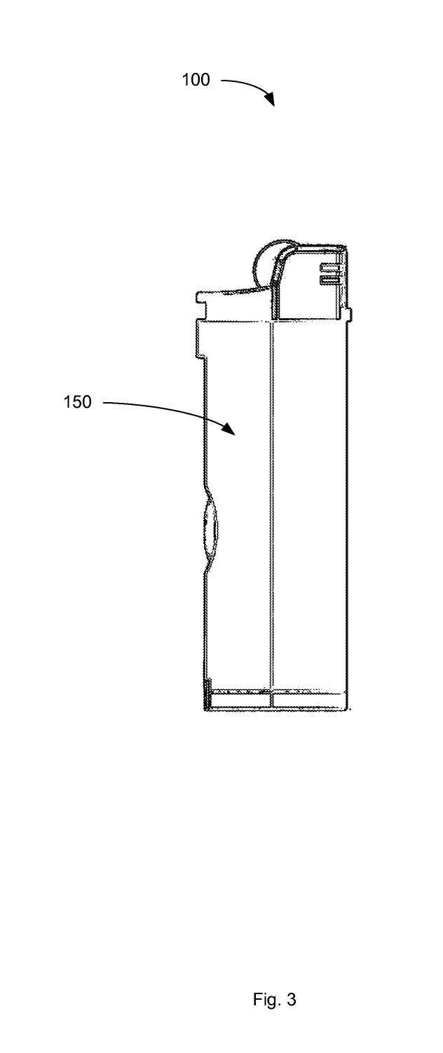

FIG. 3 is a diagram illustrating a side view of a lighter 100 to house a poke tool 110 and a tweezers and dab combination tool 120 in a closed position. A cavity 150 within the lighter 100 is designed to house the poke tool 110 and tweezers and dab combination tool 120. In one embodiment, the cavity 150 may be sufficiently large so that it completely encompasses the poke tool 110 and the tweezers and dab combination tool 120 when in their closed positions. In another embodiment, the cavity 150 may be shallower, so that only portions of the poke tool 110 and tweezers and dab combination tool 120 rest inside of the cavity 150 when in their closed positions.

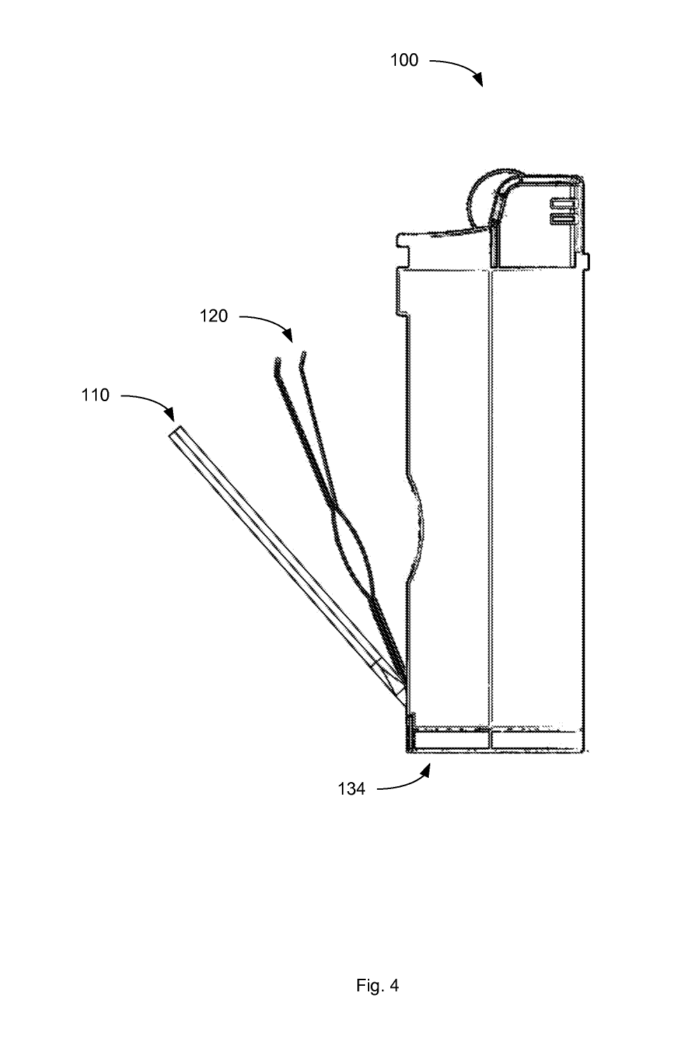

FIG. 4 is a diagram illustrating a side view of a lighter 100 to house a poke tool 110 and a tweezers and dab combination tool 120 in their open positions. In one embodiment, the tools may pivot along an axis at the second end 134 of the lighter, as shown in FIG. 4. In another embodiment, the tools may pivot from the top of the lighter (e.g., the first end 132) instead. In one embodiment, the tools may be spring loaded, so that they spring into an open position when pulled out of a closed position. In another embodiment, the tools may rely on tension about the pin 230 to keep them in an open or closed position. In another embodiment, the tools may swing freely about their pivoting axis.

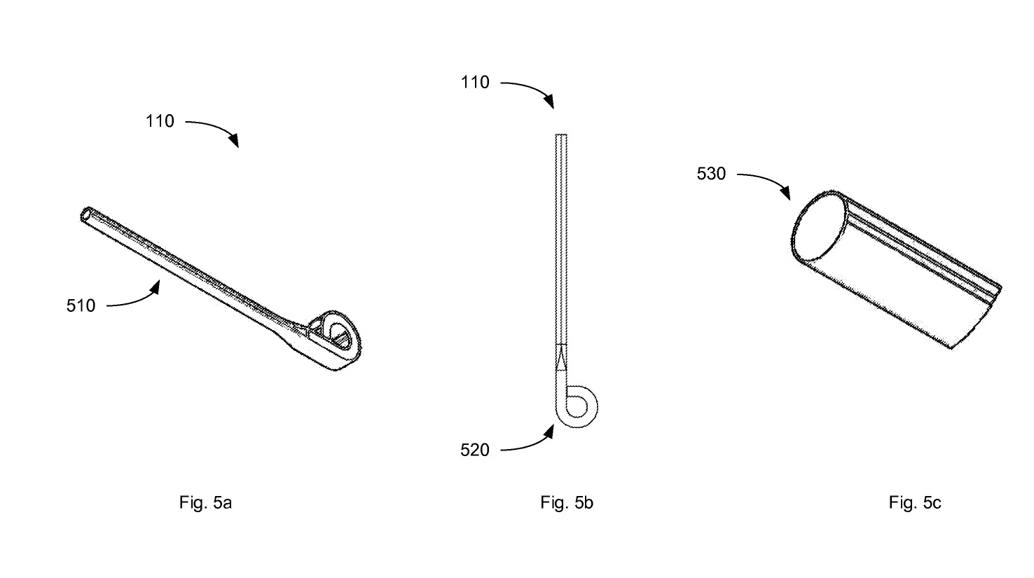

FIG. 5a is a diagram illustrating a close-up view of a poke tool, according to an embodiment. In one embodiment, the poke tool 110 may be made of a hard plastic. In another embodiment, the poke tool 110 may be made of metal. In one embodiment, an elongated portion 510 of the poke tool 110 may be cylindrical. In another embodiment, the poke tool 110 may be hexagonal or some other shape (e.g., the elongated portion having two or more sides). The elongated portion 510 may be inserted into a pipe in order to clean ash or other debris from the interior of the pipe.

FIG. 5b is a diagram illustrating a side view of a poke tool 110, according to an embodiment. In one embodiment the poke tool 110 may be made of a single piece of material. The poke tool 110 may include a ring 520 to house a pin, such as pin 230, at the end of the poke tool. The ring 520 may be bent or formed from the same piece of material which comprises the elongated portion 510 of poke tool 110 itself. In another embodiment, the ring 520 may be formed from a different piece of material from the rod and they may be joined during manufacturing. This would allow variations in material between rod and ring, so that a rod may be made of a hard plastic and a ring may be made of metal or vice versa.

FIG. 5c is a diagram illustrating a detailed view of the tip of a poke tool 110. In one embodiment, the tip 530 of the poke tool 110 may be flat. In other embodiments, however, the tip 530 may come to a point, be rounded off, or have some other shape.

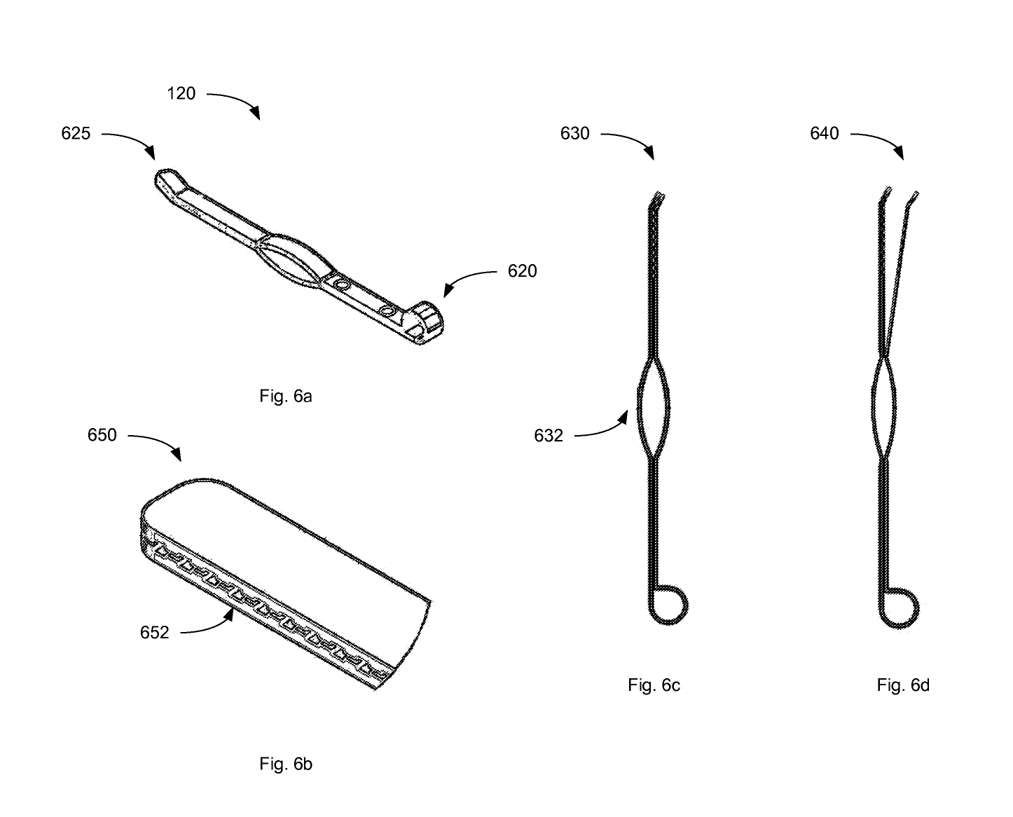

FIG. 6a is a diagram illustrating a close-up view of a tweezers/dab combination tool, according to an embodiment. In one embodiment the tweezers and dab combination tool 120 may be made of a single piece of material. In this case, the material may be formed as a single piece of plastic or bent from a single piece of metal. The tweezers and dab combination tool 120 may include a ring 620 at one end (i.e., the mating end), which may be formed from the same material as the body of the tool 120. In another embodiment, the ring 620 may be formed from a different piece of material or different type of material from the material comprising the body of the tweezers and dab combination tool 120.

The dab portion 625 of the tweezers and dab combination tool 120 may be at the end of the tool (i.e., the free end), opposite the ring 620. The dab portion 625 may be bent at an angle thus allowing easier access to THC when scooped out of a container. For example, the dab portion 625 may be angled up and away from the elongated arms of the tweezers and dab combination tool 120. The angle may be approximately 20 degrees, 45 degrees, 60 degrees, or some other angle greater than zero. In other embodiments, the dab portion 625 may be angled down, to the side, or in some other orientation. In one embodiment, the dab portion 625 of the tool may have beveled edges, as shown in FIG. 6a. In another embodiment, the corners of the dab portion 625 of the tool may be square, pointed, or be rounded off.

FIG. 6b is a diagram illustrating a detailed view of the tip 650 of a tweezers/dab combination tool 120, according to an embodiment. In one embodiment, the tip may include the dab potion 625. The interior surfaces of the elongated arms at the tip 650 (i.e., the surfaces that contact when another when closed) may include striated gripping surface 652 comprising alternating portions of raised material as seen in FIG. 6b. The alternating portions of the interior surface of the tweezers' arms may be situated such that the portions interlock each other when the arms are in a closed position. Alternatively, the raised portions of the gripping surface may mate together and not fit inside of each other when the tweezers are in a closed position.

FIG. 6c is a diagram illustrating a side view of a tweezers/dab combination tool with the tweezers in a closed position, according to an embodiment. When no pressure is applied to the middle portion 632 of the tweezers the elongated arms 630 remain in a closed position.

FIG. 6d is a diagram illustrating a side view of a tweezers/dab combination tool 120 with the tweezers 640 in an open position. When pressure is applied to the middle portion 632 of the tweezers, the pressure causes the ends of the tweezers' arms to bend away from each other, thus allowing an object (such as a cigarette) to be inserted between the arms. When pressure is released from the middle portion 632 of the tweezers, the tweezers' arms may spring back into a closed position. In this manner, a cigarette or any other object may be held by the tweezers and dab combination tool 120.

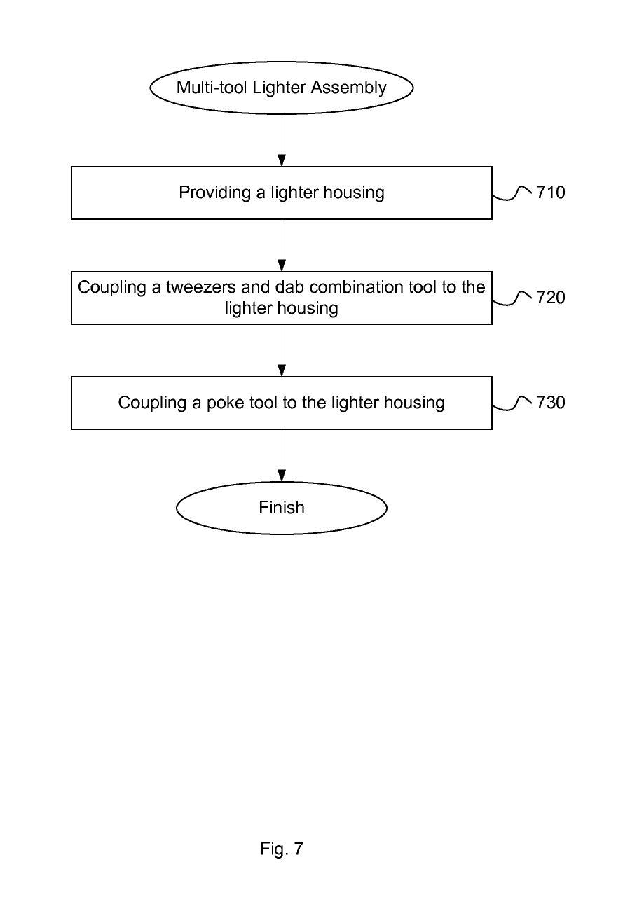

FIG. 7 is a diagram illustrating a method 700 of assembling a multi-tool lighter, according to an embodiment. In one embodiment, at block 710, method 700 provides a lighter housing. The lighter housing may include a flame emitter portion at a first end of the lighter housing. The lighter housing may further include a cavity recessed within one side of the housing, the cavity extending at least a portion of a length between a second end and the first end, the cavity to house the tweezers and dab combination tool and the poke tool when the tweezers and tab combination tool and the poke tool are in a closed position. The lighter housing may act as a handle for the tools while in an open position.

At block 720, method 700 couples a tweezers and dab combination tool to the lighter housing. The tweezers and dab combination tool may include a pair of elongated arms connected at a mating end, each arm of the pair of elongated arms having a free end opposite the mating end and positioned adjacent the free end of the other arm, where a tip of each free end is angled away from a central axis of the elongated arms to form a dab portion of the tool, and wherein the mating end is coupled to the lighter housing.

At block 730, method 700 couples a poke tool to the lighter housing. The poke tool may include a rod, having a base end and a tip end, wherein the base end of the rod is coupled to the lighter housing.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. An apparatus comprising:
a lighter housing comprising a flame emitter portion at a first end of the lighter housing;
a tweezers and dab combination tool coupled to the lighter housing at a second end, the tweezers and dab combination tool comprising a pair of elongated arms connected at a mating end, each arm of the pair of elongated arms having a free end opposite the mating end and positioned adjacent the free end of the other arm, where a tip of each free end is angled away from a central axis of the elongated arms to form a dab portion of the tool, and wherein the mating end is coupled to the lighter housing; and
a poke tool coupled to the lighter housing at the second end, the poke tool comprising a rod, having a base end and a tip end, wherein the base end of the rod is coupled to the lighter housing.

2. The apparatus of claim 1, wherein the housing further comprises:
a cavity recessed within one side of the housing, the cavity extending at least a portion of a length between a second end and the first end, the cavity to house the tweezers and dab combination tool and the poke tool when the tweezers and tab combination tool and the poke tool are in a closed position.

3. The apparatus of claim 2, wherein the tweezers and dab combination tool and the poke tool are coupled to the housing by a pin, the tweezers and dab combination tool and the poke tool to independently pivot on a radial axis around the pin between the closed position and an open position.

4. The apparatus of claim 1, wherein the tweezers and dab combination tool further comprise:
a middle portion where the elongated arms bend away from each other;
an inner portion of each elongated arm having a striated gripping surface; and
a ring at the mating end, to encompass a pin in the housing, the pin to couple the tweezers and dab combination tool to the housing.

5. The apparatus of claim 1, wherein the poke tool further comprises a ring at the base end, to encompass a pin in the housing, the pin to couple the poke tool to the housing.

6. The apparatus of claim 1, wherein the dab portion of the tweezers and dab combination tool further comprises a beveled tip, the tip forming a point on one edge of the elongated arms at the free end.

7. The apparatus of claim 1, wherein the dab portion of the tweezers and dab combination tool further comprises a pointed tip along the central axis of the elongated arms at the free end.

8. The apparatus of claim 1, wherein the dab portion of the tweezers and dab combination tool further comprises a rounded tip, forming a smooth radius at the free end.

9. A method comprising:
providing a lighter housing comprising a flame emitter portion at a first end of the lighter housing;
coupling a tweezers and dab combination tool to the lighter housing, the tweezers and dab combination tool comprising a pair of elongated arms connected at a mating end, each arm of the pair of elongated arms having a free end opposite the mating end and positioned adjacent the free end of the other arm, where a tip of each free end is angled away from a central axis of the elongated arms to form a dab portion of the tool, and wherein the mating end is coupled to the lighter housing; and
coupling a poke tool to the lighter housing, the poke tool comprising a rod, having a base end and a tip end, wherein the base end of the rod is coupled to the lighter housing.

10. The method of claim 9, wherein the lighter housing comprises a cavity recessed within one side of the housing, the cavity extending at least a portion of a length between a second end and the first end, the cavity to house the tweezers and dab combination tool and the poke tool when the tweezers and tab combination tool and the poke tool are in a closed position.

11. The method of claim 10, wherein a pin is inserted into the rings on the tweezers and dab combination tool and the poke tool and coupled to the housing, the tweezers and dab combination tool and the poke tool to independently pivot on a radial axis around the pin between the closed position and an open position.

12. The method of claim 9, wherein the dab combination tool further comprises:
a middle portion where the elongated arms are bent away from each other;
a striated gripping surface on an inner portion of each elongated arm; and
a ring at the mating end, to encompass a pin in the housing, the pin to couple the tweezers and dab combination tool to the housing.

13. The method of claim 9, wherein the poke tool further comprises a ring at the base end, to encompass a pin in the housing, the pin to couple the poke tool to the housing.

14. The method of claim 9, wherein the dab portion of the tweezers and dab combination tool further comprises a beveled tip, the tip forming a point on one edge of the elongated arms at the free end.

15. The method of claim 9, wherein the dab portion of the tweezers and dab combination tool further comprises a pointed tip along the central axis of the elongated arms at the free end.

16. The method of claim 9, wherein the dab portion of the tweezers and dab combination tool further comprises a rounded tip, forming a smooth radius at the free end.
